(19) United States
(12) Patent Application Publication
(10) Pub. No.: US 2025/0348445 A1
(43) Pub. Date: Nov. 13, 2025

(54) MULTIPLE PROCESSING UNIT COMMUNICATIONS USING ZERO-COPY PINNED COMPUTE EXPRESS LINK MEMORY

(71) Applicant: Micron Technology, Inc., Boise, ID (US)

(72) Inventors: Jacob M. JACOB, Cedar Park, TX (US); Katya GIANNIOS, West Lafayette, IN (US); Bambi DELAROSA, Frisco, TX (US)

(21) Appl. No.: 19/171,919

(22) Filed: Apr. 7, 2025

Related U.S. Application Data
(60) Provisional application No. 63/645,447, filed on May 10, 2024.

(51) Int. Cl. G06F 13/16; G06F 13/42

(52) U.S. Cl. CPC G06F 13/1668; G06F 13/4221

(57) ABSTRACT

In some implementations, a compute express link (CXL) compliant memory system may configure a portion of a memory as a shared memory region directly accessible by multiple fabric-attached processing units. The CXL compliant memory system may establish, with a first and second fabric-attached processing unit, a first and second device direct access link, respectively, to the shared memory region. The CXL compliant memory system may receive, via the first device direct access link and from the first fabric-attached processing unit, communication information associated with communications between the multiple fabric-attached processing units. The CXL compliant memory system may store the communication information in the shared memory region. The CXL compliant memory system may permit, via the second device direct access link and by using a zero-copy operation, access to the communication information by the second fabric-attached processing unit.

### CROSS-REFERENCE TO RELATED APPLICATION

This Patent Application claims priority to U.S. Provisional Patent Application No. 63/645,447, filed on May 10, 2024, entitled “MULTIPLE PROCESSING UNIT COMMUNICATIONS USING ZERO-COPY PINNED COMPUTE EXPRESS LINK MEMORY,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to multiple processing unit communications using zero-copy pinned compute express link memory.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL). For example, the memory device may be a CXL compliant memory system and/or may include a CXL interface.

### BRIEF DESCRIPTION OF THE DRAWINGS

FIG. 1 is a diagram illustrating an example system capable of enabling multiple processing unit communications using zero-copy pinned CXL memory.

FIG. 2 is a diagram illustrating another example system capable of enabling multiple processing unit communications using zero-copy pinned CXL memory.

FIG. 3 is a diagram of an example implementation associated with a CXL compliant memory system.

FIG. 4 is a flowchart of an example method associated with multiple processing unit communications using zero-copy pinned CXL memory.

FIG. 5 is a flowchart of another example method associated with multiple processing unit communications using zero-copy pinned CXL memory.

### DETAILED DESCRIPTION

In the realm of high-performance computing, particularly when it comes to deep learning applications, the ever-increasing size of deep learning models presents substantial challenges. These models often require a significant amount of memory, which has historically been provided by dynamic random access memory (DRAM). However, the growth rate of DRAM capacity has not kept pace with the demands of these expanding models. The disparity between the growth of model sizes and memory capacity has led to a pressing need for alternative solutions that can accommodate the computational requirements of large-scale, deep-learning models.

Despite the existence of collective communication frameworks that have been integrated into deep-learning algorithms, the scaling of systems using a large number of processing units (sometimes referred to herein as xPUs) can lead to inefficiencies. As the number of xPUs increases beyond a certain point, the communication overhead between distant nodes becomes a bottleneck, adversely affecting the overall system performance. This issue is exacerbated by the redundancy in data replication across the xPUs and the substantial communication overhead introduced by distributed strategies for deep learning.

These limitations of existing solutions underscore the need for a more efficient method of communication within multi-xPU systems (e.g., multi-accelerator systems, among other examples), particularly for deep-learning applications that demand high levels of parallelism and data sharing. The technical problem, therefore, lies in finding an approach that can overcome the communication bottlenecks and data redundancy issues associated with existing collective communication methods, while also optimizing the use of computational resources in systems with a large number of xPUs.

Some implementations described herein provide a method to address the communication bottlenecks and data redundancy in high-performance computing, specifically in deep-learning applications with large-scale models. For example, a CXL compliant memory system may be configured to establish direct connections to a pinned memory region with multiple processing units and facilitate communication between them by storing and permitting access to communication information within the pinned memory region. For example, in some implementations, the CXL compliant memory system may enable zero-copy access of communication information by the processing units, and/or the pinned memory region may be mapped into the virtual memory space of these processing units. The memory region can be interpreted as tensors that are pinned using host register functions associated with the processing units.

In this way, the techniques described herein may enable efficient communication between processing units without the need for data replication or the overhead of traditional collective communication methods. This direct communication through the shared, pinned memory region in the CXL compliant memory system may reduce latency and/or increase throughput in data exchanges between processing units, regardless of their physical proximity. In this way, systems employing the techniques described herein may experience a reduction in communication latency and/or the elimination of redundant data movement across the systems, which may conserve processing resources and/or memory bandwidth. By optimizing the use of computational resources and minimizing communication overhead, the techniques described herein may facilitate faster training times for deep-learning models and improve the overall efficiency of high-performance computing operations. In this way, the techniques described herein may conserve processing resources, memory resources, network resources, and/or the like, leading to more sustainable and cost-effective high-performance computing environments.

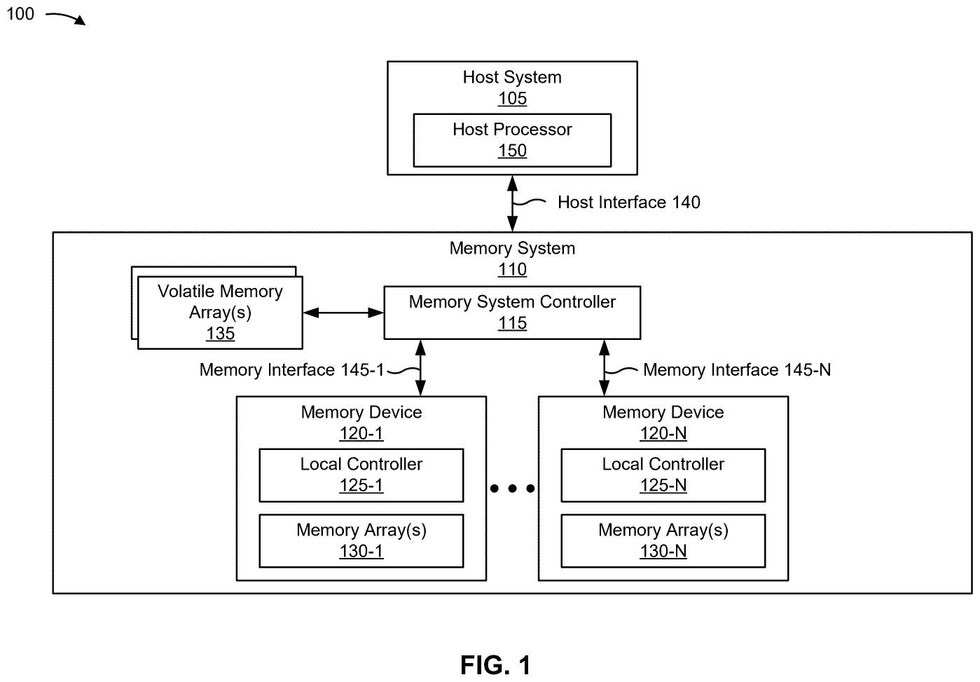

FIG. 1 is a diagram illustrating an example system 100 capable of enabling multiple processing unit communications using zero-copy pinned CXL memory. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

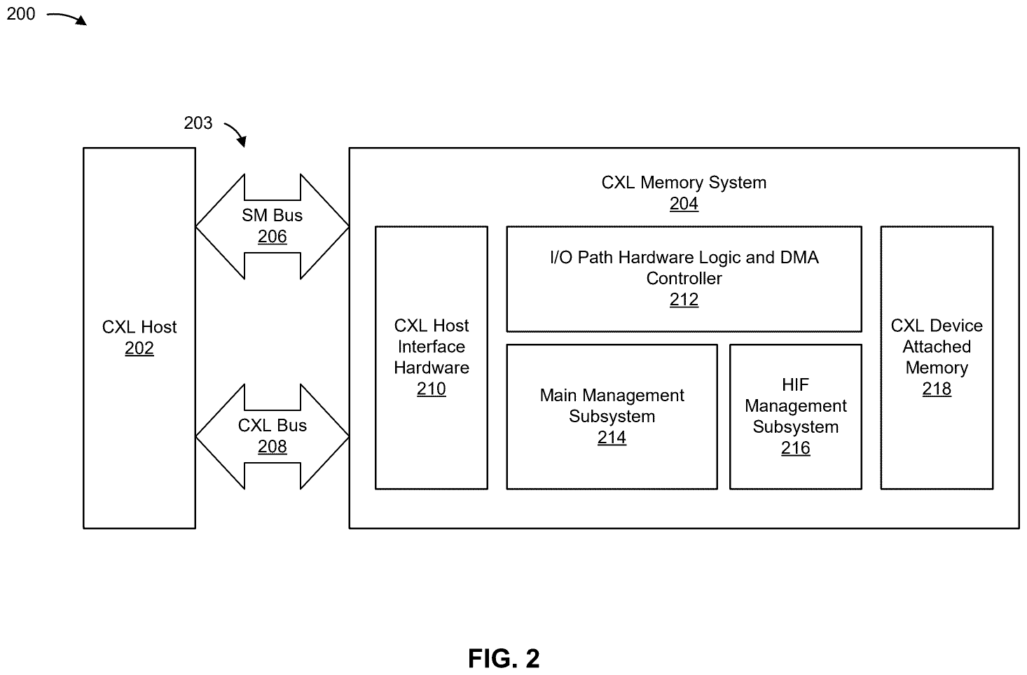

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to establish, with a first processing unit, a first direct connection to a pinned memory region of a CXL compliant memory system; establish, with a second processing unit, a second direct connection to the pinned memory region of the CXL compliant memory system; and facilitate communication between the first processing unit and the second processing unit by receiving, via the first direct connection, communication information; storing the communication information in the pinned memory region of the CXL compliant memory system; and permitting, via the second direct connection, access to the communication information by the second processing unit.

In some implementations, one or more systems, devices, apparatuses, components, and/or controllers of FIG. 1 may be configured to configure a portion of a memory of a CXL compliant memory system as a shared memory region directly accessible by multiple fabric-attached processing units; establish, with a first fabric-attached processing unit, of the multiple fabric-attached processing units, a first device direct access link to the shared memory region; establish, with a second fabric-attached processing unit, of the multiple fabric-attached processing units, a second device direct access link to the shared memory region; receive, via the first device direct access link and from the first fabric-attached processing unit, communication information associated with communications between the multiple fabric-attached processing units; store the communication information in the shared memory region; and permit, via the second device direct access link and by using a zero-copy operation, access to the communication information by the second fabric-attached processing unit.

In some implementations, one or more systems, devices, apparatuses, components, and/or controllers of FIG. 1 may be configured to establish a direct connection to a shared memory region of a CXL compliant memory system, wherein the CXL compliant memory system is configured to enable zero-copy access to the shared memory region by multiple processing unit devices; map the shared memory region into a virtual memory space of a processing unit device, resulting in a mapped region; and pin the mapped region, resulting in a pinned region, to enable direct memory access operations between the processing unit device and the pinned region.

In some implementations, one or more systems, devices, apparatuses, components, and/or controllers of FIG. 1 may be configured to establish a direct connection to a shared memory region of a CXL compliant memory system, wherein the CXL compliant memory system is configured to enable zero-copy access to the shared memory region by multiple processing units; map the shared memory region into a virtual memory space of a processing unit, resulting in a mapped region; and pin the mapped region, resulting in a pinned region, to enable direct memory access operations between the processing unit and the pinned region.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 enabling multiple processing unit communications using zero-copy pinned CXL memory. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL host, and a memory device, sometimes referred to as a CXL device) and/or may be a CXL compliant system. In that regard, the system 200 may include a CXL compliant host 202 (which may correspond to the host system 105) and a CXL compliant memory system 204 (which may correspond to the memory system 110). The CXL compliant host 202 and the CXL compliant memory system 204 may communicate via an interface 203 (e.g., host interface 140), which may include a system management (SM) bus 206 and/or a CXL bus 208 (e.g., a PCIe/CXL interface), among other examples.

In some examples, the CXL compliant memory system 204 (sometimes referred to herein as a CXL memory system, a CXL memory device, a CXL memory module, a CXL device, and/or a similar term) may be a system that complies with the CXL standard and/or protocol, such as for a purpose of communicating with one or more host devices (e.g., CXL compliant host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL compliant host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL compliant host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory controller (which may correspond to the memory system controller 115 and/or local controller 125), which may be configured to manage data flow between memory arrays (shown as CXL attached memory 218, which may correspond to the volatile memory arrays 135 and/or the memory arrays 130) and a CXL interface (e.g., the CXL bus 208). In some examples, the CXL memory controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL controller (e.g., an ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL compliant host 202 via the SM bus 206 and/or the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL compliant host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL compliant host 202, error handling, and/or other protocol-specific functionalities. Additionally, or alternatively, the HIF management subsystem 216 may ensure smooth communication between the CXL compliant memory system 204 and/or the CXL compliant host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

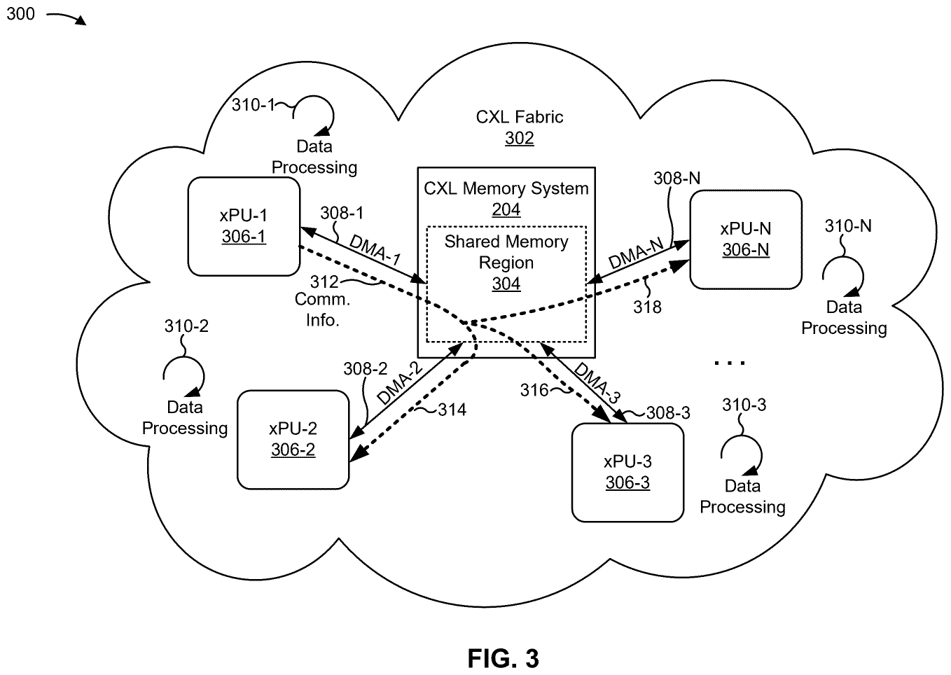

FIG. 3 is a diagram of an example implementation 300 associated with a CXL compliant memory system for efficient communication and data sharing among fabric-attached processing units. As shown in FIG. 3, example implementation 300 includes a CXL fabric 302, the CXL compliant memory system 204 including a shared memory region 304 (e.g., a portion of the CXL attached memory 218 that is accessible by multiple processing units, referred to herein as xPUs 306, which may correspond to central processing units (CPUs), graphics processing units (GPUs), neural processing units (NPUs), vision processing units (VPUs), tensor processing units (TPUs), AI accelerators, infrastructure processing units (IPUs), field programmable gate arrays (FPGAs), and/or similar processing units), and the multiple xPUs 306 (shown in FIG. 3 as a first xPU 306-1 through an N-th xPU 306-N, each of which may correspond to a host device, such as the CXL compliant host 202 described above in connection with FIG. 2). In some implementations, the xPUs 306 may be connected to the CXL compliant memory system 204 (and, more particularly, to the shared memory region 304 of the CXL compliant memory system 204) via the CXL fabric 302 (e.g., a network topology enabling interconnection between the xPUs 306 and the CXL compliant memory system 204). In that regard, in some implementations, the xPUs 306 may be referred to as fabric-attached xPUs, or, more simply, fabric-attached processing units, and/or the CXL compliant memory system 204 may be referred to as a fabric-attached memory (FAM).

In some implementations, the shared memory region 304 may be a portion of a memory of the CXL compliant memory system 204 that is configured as a shared memory region directly accessible by the xPUs 306. For example, the CXL compliant memory system 204 may allocate a specific memory range within the CXL compliant memory system 204 architecture to serve as the shared memory region 304, which may be designed to be directly accessed by the various xPUs without the need for data replication or redundant storage. In that regard, the shared memory region 304 may facilitate efficient communication and data sharing among the xPUs 306, which may be particularly beneficial in high-performance computing environments where large-scale, parallel processing is required.

In that regard, the CXL compliant memory system 204 may establish, with each xPU 306 and/or via the CXL fabric 302, a direct link to the shared memory region 304. For example, the CXL compliant memory system 204 may establish a DMA link 308 between each xPU 306 and the shared memory region 304. More particularly, the CXL compliant memory system 204 may establish, with the first xPU 306-1, a first DMA link 308-1 to the shared memory region 304; the CXL compliant memory system 204 may establish, with the second xPU 306-2, a second DMA link 308-2 to the shared memory region 304; the CXL compliant memory system 204 may establish, with the third xPU 306-3, a third DMA link 308-3 to the shared memory region 304; and so forth through an N-th DMA link 308-N to the shared memory region 304 established with the N-th xPU 306-N.

In some implementations, to enable each xPU 306 to establish a DMA link 308 with the shared memory region 304, the CXL compliant memory system 204 (e.g., the shared memory region 304 of the CXL compliant memory system 204) may be made available as a direct access (DAX) device, such as by associating the CXL compliant memory system 204 with a /dev/dax file (e.g., /dev/dax0.0, among other examples) in a Linux file system, among other examples. Additionally, or alternatively, in some implementations, an application programming interface (API) function may be used to page-lock a specific memory range of the CXL compliant memory system 204 (e.g., a memory range associated with the shared memory region 304), thereby permitting the xPUs 306 to directly access the shared memory region 304 with higher bandwidth and lower latency than for pageable memory that has not been registered, while avoiding an extra load associated with copying data from memory to an xPU 306 memory, as is typically needed for certain mapping operations, such as memory map (mmap) operations in a Linux file system. In some implementations, the direct access links (e.g., the DMA links 308) may enable fast and efficient point-to-point (P2P) communication among the xPUs 306. Moreover, establishing direct access links with each of the xPUs 306 may enable the xPUs 306 to participate in collective communication operations. Additionally, or alternatively, this setup may enable a scalable and efficient communication framework that can support a large number of xPUs 306.

In some implementations, the shared memory region 304 may be used as a communication transport between the various xPUs 306, such as when the xPUs are performing parallel computations as part of a collective operation (e.g., when the xPUs 306 are employed as a part of a deep-learning model, among other examples). As used herein, “parallelism” and/or “parallel computation” refers to the simultaneous execution of multiple tasks and/or operations to achieve faster processing and/or improved performance, among other examples. In some implementations, parallelism may be used to handle large-scale computations efficiently, such as by distributing the workload across multiple computing resources (e.g., multiple xPUs 306). In some implementations, the multiple computing resources may be configured to perform model-parallel computations, in which different parts or components of a computational model are processed in parallel across the multiple computing resources (e.g., such as when a single model is too large to fit into a memory of a single device, among other examples). Additionally, or alternatively, the multiple computing resources may be configured to perform tensor-parallel computations, which may involve parallelizing operations on tensors (e.g., multi-dimensional arrays commonly used in machine learning and scientific computing, among other examples), which may involve distributing tensor operations across the multiple computing resources (e.g., such as for a purpose of improving efficiency for tasks like matrix multiplication and/or convolutional operations, among other examples). Additionally, or alternatively, the multiple computing resources may be configured to perform pipeline-parallel computations, which may involve dividing computational tasks into stages, with each stage executed concurrently and/or with each stage being associated with processing a portion of the data and passing the processed data to the next stage (e.g., such as for a purpose of performing tasks with sequential dependencies, where each stage depends on an output of a previous stage). Additionally, or alternatively, the multiple computing resources may be configured to perform data-parallel computations, which may involve distributing data across the multiple computing resources and/or performing the same operation on each subset of the data simultaneously (e.g., such as for a purpose of dividing large datasets are into smaller chunks for processing independently and then combined to produce the final result). Additionally, or alternatively, the multiple computing resources may be configured to perform hybrid-parallel computations, which may combine multiple forms of parallelism to leverage the advantages of different approaches (e.g., a computation might involve both data parallelism and model parallelism to efficiently utilize both computing resources and memory). Additionally, or alternatively, one or more of the parallelization techniques described herein may be referred to as, or may be associated with, horizontal parallelization, which may involve distributing tasks or data across multiple computing resources, with each computing resource performing a portion of the overall computation independently, such as for a purpose of scaling out computations by adding more nodes or machines to the system. Additionally, or alternatively, one or more of the parallelization techniques described herein may be referred to as, or may be associated with, vertical parallelization, which may involve breaking down a task into smaller subtasks that can be executed concurrently on the same processing unit, such as for a purpose of exploiting parallelism within a single device (e.g., multi-core CPUs or GPUs, among other examples) by dividing the workload among different processing elements.

In that regard, the shared memory region 304 may be used as a communication transport between the various xPUs 306, such as when the xPUs 306 are performing one of the parallel computations described above. For example, as shown by reference number 312, in some implementations the CXL compliant memory system 204 may receive, via the first DMA link 308-1 and from the first xPU 306-1, communication information associated with communications between the multiple xPUs 306. For example, the first xPU 306-1 may transmit data, such as gradients and/or parameters, which may form part of a distributed, deep-learning computation, to the shared memory region 304 via the established first DMA link 308-1.

In some implements, the CXL compliant memory system 204 may store the communication information in the shared memory region 304. For example, the received communication information may be stored in the designated shared memory region 304 for access by the other xPUs 306 without the need for the other xPUs 306 to copy the communication information into local memory of the xPUs, thereby reducing overhead and improving the overall efficiency of the system.

More particularly, as shown by reference number 314, the CXL compliant memory system 204 may permit, via the second DMA link 308-2, access to the communication information by the second xPU 306-2. For example, the CXL compliant memory system 204 may permit, via the second DMA link 308-2, access to the communication information by the second xPU 306-2 using a zero-copy operation, such that the second xPU 306-2 may access the communication information stored in the shared memory region 304 directly, without the need to copy the data into local memory associated with the second xPU 306-2, which may reduce latency and/or increase the speed of data access. Similarly, as shown by reference numbers 316 and 318, the CXL compliant memory system 204 may permit, via the third DMA link 308-3 and the N-th DMA link 308-2, respectively, access to the communication information by the third xPU 308-2 and the N-th xPU 308-N. For example, the CXL compliant memory system 204 may permit, via the third DMA link 308-3 and the N-th DMA link 308-N, access to the communication information by the third xPU 306-2 and the N-th xPU 306-N, respectively, such by the third xPU 306-2 and the N-th xPU 306-N using a zero-copy operation to access the communication information stored in the shared memory region 304 directly, without the need to copy the data into local memory associated with the third xPU 306-2 and the fourth xPU 306-N.

In some aspects, the DMA links 308 may be associated with the shared memory region 304 being mapped into a virtual memory space of the xPUs 306. For example, to establish a direct access link (e.g., a DMA link 308) to the shared memory region 304, an xPU 306 may map the shared memory region 304 into a virtual memory space of the xPU 306, resulting in a mapped region. For example, an xPU 306 may map the shared memory region 304 in a virtual memory space using an mmap operation, or a similar operation. Additionally, or alternatively, the xPUs 306 may interpret the mapped region as tensors (e.g., a multi-dimensional array and/or data structure that is stored in a memory). In some implementations, mapping the shared memory region 304 in a virtual memory space (e.g., by using an mmap operation) and/or interpreting the mapped region as tensors may be performed by the xPUs 306 without copying data from the shared memory region 304 into memory associated with the xPU 306.

Additionally, or alternatively, the xPUs 306 may pin the mapped region (e.g., the tensors, sometimes referred to herein as FAM tensors), resulting in a pinned region that may enable direct memory access operations between the xPU 306 and the pinned region (e.g., the shared memory region 304). In this regard, in some implementations, the shared memory region 304 may be referred to as a pinned memory region. For example, in some implementations, an xPU 306 may pin an FAM tensor using a host register function, such as a host register function associated with a compute unified device architecture (CUDA) API, sometimes referred to as cudaHostRegister. Additionally, or alternatively, in some implementations, an xPU 306 may pin a FAM tensor using a host register function associated with a heterogenous-compute interface for portability (HIP) API, sometimes referred to as hipHostRegister.

In such implementations, pinning the shared memory region 304 at the xPUs 306 (e.g., resulting in the pinned memory region) may enable the xPUs 306 to interpret and/or manipulate data contained in the shared memory region 304 as if the data was local (e.g., as if the data was stored on local memory at the xPUs 306) while ensuring that the shared memory region 304 will not be swapped out by the xPUs, as may occur for regular xPU memory pages. That is, once a given xPU 306 (sometimes referred to as an xPU kernel) pins a tensor in this manner and/or a similar manner, the xPU 306 may perform fast-copy or zero-copy operations on the tensor without using a memory buffer (e.g., a bounce buffer) on the host system (e.g., CXL compliant host 202) to copy the data from the shared memory region 304 and then transferring the data to a CPU associated with host system. In some implementations, this may be performed by engaging a DMA engine to do a data transfer directly. Additionally, or alternatively, pinning the shared memory region 304 with host registering (e.g., by using cudaHostRegister, hipHostRegister, and/or a similar host register function) before calling collectives (e.g., such as an NVIDIA collective communication library (NCCL) communication register, sometimes referred to as ncclCommRegister, among other examples) may enable certain frameworks, such as a PyTorch distributed package (sometimes referred to as torch.distributed) and/or a similar deep-learning programing framework, to leverage FAM zero-copy functionality.

Put another way, in some implementations, the first DMA link 308-1 may be associated with the first xPU 306-1 pinning a first tensor using a first host register function associated with the xPU 306-1, the second DMA link 308-2 may be associated with the second xPU 306-2 pinning a second tensor using a second host register function associated with the second xPU 306-2, and so forth through the N-th DMA link 308-N being associated with the N-th xPU 306-N pinning an N-th tensor using an N-th host register function associated with the N-th xPU 306-N. In this regard, the CXL compliant memory system 204 may enable access to the communication information by the xPUs 306 without requiring copying of the communication information from the shared memory region 304 to each respective xPU 306. That is, the data may be transferred via the DMA directly between the FAM and a respective xPU 306 (e.g., GPU) without unnecessarily copying the data into a CPU memory buffer. In this way, CPU bouncing may be avoided, resulting in zero-copy access of the data in the shared memory region 304 and/or GPU-direct access of the data in the shared memory region 304. As used herein, “zero-copy access” refers to a technique where data is transferred between different parts of a system (e.g., an xPU 306 and the shared memory region 304) without a need to copy the data from one location to another (e.g., without a need to copy the data from the shared memory region 304 to a CPU memory buffer).

Accordingly, in some implementations, the xPUs 306 may directly interact with the data within the shared memory region 304, enabling distributed computations such as model-parallel, tensor-parallel, pipeline-parallel computations, data-parallel computations, hybrid-parallel computations, and/or other forms of horizontal and/or vertical parallelization.

Additionally, or alternatively, the shared memory region 304 may serve as a transport medium for communications among the xPUs 306. More particularly, as shown in connection with the communication information indicated by reference numbers 312, 314, 316, and 318, in some implementations the first xPU 306-1 may communicate with the other xPUs 306 (e.g., via a collective deep learning operation, or a similar collective operation) by the first xPU 306-1 saving data (e.g., the communication information) to the shared memory region 304 and/or by the other xPUs 306 retrieving the data from the shared memory region 304 using a zero-copy operation, or a similar operation.

In this way, the techniques described herein may enable improved collective operations, such as improved distributed operations across multiple xPUs 306 executing a deep-learning model, among other examples. For example, calling a host registering primitive (e.g., cudaHostRegister, hipHostRegister, and/or similar host registering primitives) on directly mapped CXL memory (e.g., the shared memory region 304) may be faster than traditional shared memory operations, because in traditional shared memory operations data from a disk may have to be loaded from an underlying medium into a pinned processing unit memory to initialize the pinned memory. On the other hand, CXL memory regions (e.g., the shared memory region 304) may be directly attached memory with data already stored on it, meaning no data needs to be copied from an underlying medium when accessed by a given xPU 306 (e.g., the data may be accessed using a zero-copy operation). Additionally, or alternatively, by utilizing the techniques described herein in a distributed computation across xPUs 306, data may be shared using the CXL compliant memory system 204 (e.g., using an FAM), which may enable independence from xPU 306 memory capacity and/or which may enable xPU 306 compute to scale efficiently.

As indicated above, FIG. 3 is provided as an example. Other examples may differ from what is described with regard to FIG. 3.

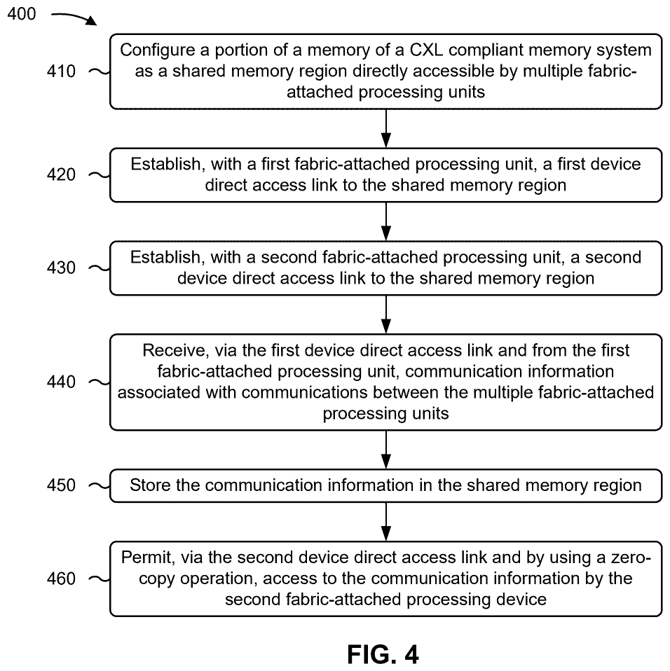

FIG. 4 is a flowchart of an example method 400 associated with multiple processing unit communications using zero-copy pinned CXL memory. In some implementations, a CXL compliant memory system (e.g., the CXL compliant memory system 204) may perform or may be configured to perform the method 400. In some implementations, another device or a group of devices separate from or including the CXL compliant memory system (e.g., the system 100 and/or the system 200) may perform or may be configured to perform the method 400. Additionally, or alternatively, one or more components of the CXL compliant memory system (e.g., the memory system controller 115, the local controller 125, and/or the main management subsystem 214) may perform or may be configured to perform the method 400. Thus, means for performing the method 400 may include the CXL compliant memory system and/or one or more components of the CXL compliant memory system. Additionally, or alternatively, a non-transitory computer-readable medium may store one or more instructions that, when executed by the CXL compliant memory system (e.g., the memory system controller 115 of the memory system 110, the local controller 125 of the memory device 120, and/or the main management subsystem 214 of the CXL compliant memory system 204), cause the CXL compliant memory system to perform the method 400.

As shown in FIG. 4, the method 400 may include configuring a portion of a memory of the CXL compliant memory system as a shared memory region directly accessible by multiple fabric-attached processing units (block 410). For example, the CXL compliant memory system 204 may configure a portion of the CXL compliant memory system 204 memory (the shared memory region 304) as a shared memory region directly accessible by multiple fabric-attached (e.g., CXL fabric 302 attached) xPUs 306, as described above. As further shown in FIG. 4, the method 400 may include establishing, with a first fabric-attached processing unit, a first device direct access link to the shared memory region (block 420). For example, the CXL compliant memory system 204 may establish the first DMA link 308-1 with the first xPU 306-1, as described above. As further shown in FIG. 4, the method 400 may include establishing, with a second fabric-attached processing unit, a second device direct access link to the shared memory region (block 430). For example, the CXL compliant memory system 204 may establish the second DMA link 308-2 with the second xPU 306-2, the third DMA link 308-3 with the third xPU 306-2, and so forth through an N-th DMA link 308-N with the N-th xPU 306-N, as described above.

As further shown in FIG. 4, the method 400 may include receiving, via the first device direct access link and from the first fabric-attached processing unit, communication information associated with communications between the multiple fabric-attached processing units (block 440). For example, the CXL compliant memory system 204 may receive, via the first DMA link 304-1, communication information (e.g., data associated with a communication between the xPU 306-1 and other xPUs 306) from the first xPU 306-1, as described above. As further shown in FIG. 4, the method 400 may include storing the communication information in the shared memory region (block 450). For example, the CXL compliant memory system 204 may store the communication information in the shared memory region 304, as described above. As further shown in FIG. 4, the method 400 may include permitting, via the second device direct access link and by using a zero-copy operation, access to the communication information by the second fabric-attached processing unit (block 460). For example, the CXL compliant memory system 204 may permit the second xPU 306-2, the third xPU 306-3, and/or the N-th xPU 306-N to access the communication information stored in the shared memory region 304 via respective DMA links 308, as described above in connection with reference numbers 314, 316, and 318.

The method 400 may include additional aspects, such as any single aspect or any combination of aspects described below and/or described in connection with one or more other methods or operations described elsewhere herein.

In a first aspect, at least one of the first device direct access link is associated with the shared memory region being mapped into a first virtual memory space of the first fabric-attached processing unit, or the second device direct access link is associated with the shared memory region being mapped into a second virtual memory space of the second fabric-attached processing unit. For example, the xPUs 306 may map the shared memory region 304 into respective virtual memory spaces at the xPUs 306, as described above.

In a second aspect, alone or in combination with the first aspect, at least one of the first device direct access link is associated with interpreting the shared memory region that is mapped into the first virtual memory space as a first tensor, or the second device direct access link is associated with interpreting the shared memory region that is mapped into the second virtual memory space as a second tensor. For example, the xPUs 306 may interpret the shared memory region 304 mapped into the virtual memory spaces as tensors, as described above.

In a third aspect, alone or in combination with one or more of the first and second aspects, at least one of the first device direct access link is associated with pinning the first tensor using a first host register function associated with the first fabric-attached processing unit, or the second device direct access link is associated with pinning the second tensor using a second host register function associated with the second fabric-attached processing unit. For example, the xPUs may pin the tensors using a host register function, such as cudaHostRegister, hipHostRegister, and/or a similar host register function, as described above.

In a fourth aspect, alone or in combination with one or more of the first through third aspects, permitting access to the communication information by the second fabric-attached processing unit is performed without copying the communication information from the shared memory region to the second fabric-attached processing unit. For example, the second xPU 306-2, the third xPU 306-3, and/or the N-th xPU 306-N may access the communication information stored in the shared memory region 304 using a zero-copy operation, as described above in connection with reference numbers 314, 316, and 318.

In a fifth aspect, alone or in combination with one or more of the first through fourth aspects, the CXL compliant memory system and the multiple fabric-attached processing units are associated with at least one of a model-parallel computation, a tensor-parallel computation, a pipeline-parallel computation, a data-parallel computation, or a hybrid-parallel computation. For example, by utilizing the shared memory region 304 as a communication transport medium, among other examples, the xPUs 306 may efficiently perform a parallel computation, such as a model-parallel computation, a tensor-parallel computation, a pipeline-parallel computation, a data-parallel computation, and/or a hybrid-parallel computation as described above.

Although FIG. 4 shows example blocks of a method 400, in some implementations, the method 400 may include additional blocks, fewer blocks, different blocks, or differently arranged blocks than those depicted in FIG. 4. Additionally, or alternatively, two or more of the blocks of the method 400 may be performed in parallel. The method 400 is an example of one method that may be performed by one or more devices described herein. These one or more devices may perform or may be configured to perform one or more other methods based on operations described herein.

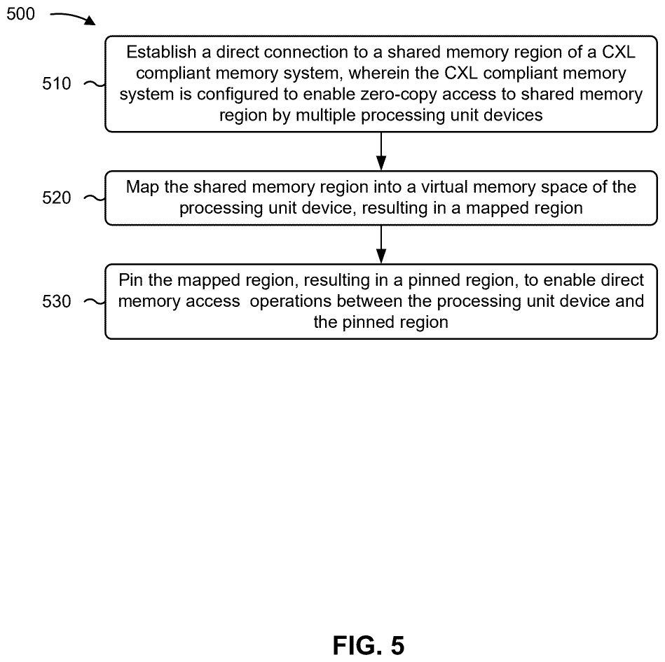

FIG. 5 is a flowchart of another example method 500 associated with multiple processing unit communications using zero-copy pinned CXL memory. In some implementations, a processing unit device (e.g., an xPU 306) may perform or may be configured to perform the method 500. In some implementations, another device or a group of devices separate from or including the processing unit device (e.g., the CXL compliant host 202 and/or the host system 105) may perform or may be configured to perform the method 500. Additionally, or alternatively, one or more components of the processing unit device (e.g., host processor 150) may perform or may be configured to perform the method 500. Thus, means for performing the method 500 may include the processing unit device and/or one or more components of the processing unit device. Additionally, or alternatively, a non-transitory computer-readable medium may store one or more instructions that, when executed by the processing unit device, cause the processing unit device to perform the method 500.

As shown in FIG. 5, the method 500 may include establishing a direct connection to a shared memory region of a CXL compliant memory system, wherein the CXL compliant memory system is configured to enable zero-copy access to the shared memory region by multiple processing unit devices (block 510). For example, the first xPU 306-1 may establish the first DMA link 308-1 with the shared memory region 304 of the CXL compliant memory system 204, the second xPU 306-2 may establish the second DMA link 308-2 with the shared memory region 304 of the CXL compliant memory system 204, the third xPU 306-3 may establish the third DMA link 308-3 with the shared memory region 304 of the CXL compliant memory system 204, and so forth through the N-th xPU 306-N establishing the N-th DMA link 308-N with the shared memory region 304 of the CXL compliant memory system 204, as described above. As further shown in FIG. 5, the method 500 may include mapping the shared memory region into a virtual memory space of the processing unit device, resulting in a mapped region (block 520). For example, the xPUs 306 may map the shared memory region 304 into respective virtual memory spaces at the xPUs 306, as described above. As further shown in FIG. 5, the method 500 may include pinning the mapped region, resulting in a pinned region, to enable direct memory access operations between the processing unit device and the pinned region (block 530). For example, the xPUs 306 may interpret the mapped regions as tensors and/or pin the tensors using a host register function, such as cudaHostRegister, hipHostRegister, and/or a similar host register function, as described above.

The method 500 may include additional aspects, such as any single aspect or any combination of aspects described below and/or described in connection with one or more other methods or operations described elsewhere herein.

In a first aspect, pinning the mapped region includes pinning the mapped region using a host register function associated with the processing unit device. For example, the xPUs 306 may pin the mapped regions using a host register function, such as cudaHostRegister, hipHostRegister, and/or a similar host register function, as described above.

In a second aspect, alone or in combination with the first aspect, the method 500 includes accessing data stored at the shared memory region by interpreting, by the processing unit device, the mapped region as a tensor without copying the data into memory associated with the processing unit device. For example, the xPUs 306 may interpret the shared memory region 304 mapped into the virtual memory spaces as tensors, such as for a purpose of performing a zero-copy operation to access the data of the shared memory region 304, as described above.

In a third aspect, alone or in combination with one or more of the first and second aspects, the method 500 includes performing, by the processing unit device, collective operations with the multiple processing unit devices using the shared memory region as a medium for communication. For example, by utilizing the shared memory region 304 as a communication transport medium (e.g., by utilizing the shared memory region 304 to exchange the communication information described above in connection with reference numbers 312, 314, 316, and 318), the xPUs 306 may efficiently perform a parallel computation, such as a model-parallel computation, a tensor-parallel computation, a pipeline-parallel computation, a data-parallel computation, and/or a hybrid-parallel computation, as described above.

In a fourth aspect, alone or in combination with one or more of the first through third aspects, the CXL compliant memory system is configured as a direct access device visible to the multiple processing unit devices. For example, the CXL compliant memory system 204 may be configured as a direct access device (e.g., a /dev/dax file in a Linux operating system) in order to enable respective DMA links 308 with the xPUs 306, as described above.

In a fifth aspect, alone or in combination with one or more of the first through fourth aspects, the method 500 includes executing, by the processing unit device, a data processing operation using the shared memory region to communicate computation results to one or more processing unit devices, of the multiple processing unit devices. For example, by utilizing the shared memory region 304 as a communication transport medium (e.g., by utilizing the shared memory region 304 to exchange the communication information described above in connection with reference numbers 312, 314, 316, and 318), the xPUs 306 may operate a data processing operation (e.g., a model-parallel computation, a tensor-parallel computation, a pipeline-parallel computation, a data-parallel computation, and/or a hybrid-parallel computation, among other examples) by communicating computation results via the shared memory region 304, as described above.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. One or more devices may perform or may be configured to perform one or more other methods based on operations described herein.

In some implementations, a CXL compliant memory system includes one or more components configured to: establish, by the CXL compliant memory system with a first processing unit, a first direct connection to a pinned memory region of the CXL compliant memory system; establish, by the CXL compliant memory system with a second processing unit, a second direct connection to the pinned memory region of the CXL compliant memory system; and facilitate, by the CXL compliant memory system, communication between the first processing unit and the second processing unit by: receiving, via the first direct connection, communication information; storing the communication information in the pinned memory region of the CXL compliant memory system; and permitting, via the second direct connection, access to the communication information by the second processing unit.

In some implementations, a method includes configuring, by a CXL compliant memory system, a portion of a memory of the CXL compliant memory system as a shared memory region directly accessible by multiple fabric-attached processing units; establishing, by the CXL compliant memory system with a first fabric-attached processing unit, of the multiple fabric-attached processing units, a first device direct access link to the shared memory region; establishing, by the CXL compliant memory system with a second fabric-attached processing unit, of the multiple fabric-attached processing units, a second device direct access link to the shared memory region; receiving, via the first device direct access link and from the first fabric-attached processing unit, communication information associated with communications between the multiple fabric-attached processing units; storing, by the CXL compliant memory system, the communication information in the shared memory region; and permitting, via the second device direct access link and by using a zero-copy operation, access to the communication information by the second fabric-attached processing unit.

In some implementations, a method includes establishing, by a processing unit device, a direct connection to a shared memory region of a CXL compliant memory system, wherein the CXL compliant memory system is configured to enable zero-copy access to the shared memory region by multiple processing unit devices; mapping, by the processing unit device, the shared memory region into a virtual memory space of the processing unit device, resulting in a mapped region; and pinning, by the processing unit device, the mapped region, resulting in a pinned region, to enable direct memory access operations between the processing unit device and the pinned region.

In some implementations, a system includes a CXL compliant memory system; and multiple processing units connected to the CXL compliant memory system via a CXL fabric, wherein one or more components of each processing unit, of the multiple processing units, are configured to: establish a direct connection to a shared memory region of the CXL compliant memory system, wherein the CXL compliant memory system is configured to enable zero-copy access to the shared memory region by the multiple processing units; map the shared memory region into a virtual memory space of the processing unit, resulting in a mapped region; and pin the mapped region, resulting in a pinned region, to enable direct memory access operations between the processing unit and the pinned region.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A compute express link (CXL) compliant memory system, comprising:
one or more components configured to:
establish, by the CXL compliant memory system with a first processing unit, a first direct connection to a pinned memory region of the CXL compliant memory system;
establish, by the CXL compliant memory system with a second processing unit, a second direct connection to the pinned memory region of the CXL compliant memory system; and
facilitate, by the CXL compliant memory system, communication between the first processing unit and the second processing unit by:
receiving, via the first direct connection, communication information;
storing the communication information in the pinned memory region of the CXL compliant memory system; and
permitting, via the second direct connection, access to the communication information by the second processing unit.

2. The CXL compliant memory system of claim 1, wherein at least one of the first direct connection or the second direct connection are associated with a device direct access link.

3. The CXL compliant memory system of claim 1, wherein at least one of:
the first direct connection is associated with the pinned memory region of the CXL compliant memory system being mapped into a first virtual memory space of the first processing unit, or
the second direct connection is associated with the pinned memory region of the CXL compliant memory system being mapped into a second virtual memory space of the second processing unit.

4. The CXL compliant memory system of claim 3, wherein at least one of:
the first direct connection is associated with interpreting the pinned memory region of the CXL compliant memory system that is mapped into the first virtual memory space as a first tensor, or
the second direct connection is associated with interpreting the pinned memory region of the CXL compliant memory system that is mapped into the second virtual memory space as a second tensor.

5. The CXL compliant memory system of claim 4, wherein at least one of:
the first direct connection is associated with pinning the first tensor using a first host register function associated with the first processing unit, or
the second direct connection is associated with pinning the second tensor using a second host register function associated with the second processing unit.

6. The CXL compliant memory system of claim 1, wherein permitting access to the communication information by the second processing unit is performed without copying the communication information from the pinned memory region of the CXL compliant memory system to the second processing unit.

7. The CXL compliant memory system of claim 1, wherein permitting access to the communication information includes performing, with the second processing unit, a zero-copy access of the communication information.

8. The CXL compliant memory system of claim 1, wherein the CXL compliant memory system, the first processing unit, and the second processing unit are associated with at least one of:
a model-parallel computation,
a tensor-parallel computation,
a pipeline-parallel computation,
a data-parallel computation, or
a hybrid-parallel computation.

9. A method, comprising:
configuring, by a compute express link (CXL) compliant memory system, a portion of a memory of the CXL compliant memory system as a shared memory region directly accessible by multiple fabric-attached processing units;
establishing, by the CXL compliant memory system with a first fabric-attached processing unit, of the multiple fabric-attached processing units, a first device direct access link to the shared memory region;
establishing, by the CXL compliant memory system with a second fabric-attached processing unit, of the multiple fabric-attached processing units, a second device direct access link to the shared memory region;
receiving, via the first device direct access link and from the first fabric-attached processing unit, communication information associated with communications between the multiple fabric-attached processing units;
storing, by the CXL compliant memory system, the communication information in the shared memory region; and
permitting, via the second device direct access link and by using a zero-copy operation, access to the communication information by the second fabric-attached processing unit.

10. The method of claim 9, wherein at least one of:
the first device direct access link is associated with the shared memory region being mapped into a first virtual memory space of the first fabric-attached processing unit, or
the second device direct access link is associated with the shared memory region being mapped into a second virtual memory space of the second fabric-attached processing unit.

11. The method of claim 10, wherein at least one of:
the first device direct access link is associated with interpreting the shared memory region that is mapped into the first virtual memory space as a first tensor, or
the second device direct access link is associated with interpreting the shared memory region that is mapped into the second virtual memory space as a second tensor.

12. The method of claim 11, wherein at least one of:
the first device direct access link is associated with pinning the first tensor using a first host register function associated with the first fabric-attached processing unit, or
the second device direct access link is associated with pinning the second tensor using a second host register function associated with the second fabric-attached processing unit.

13. The method of claim 9, wherein permitting access to the communication information by the second fabric-attached processing unit is performed without copying the communication information from the shared memory region to the second fabric-attached processing unit.

14. The method of claim 9, wherein the CXL compliant memory system and the multiple fabric-attached processing units are associated with at least one of:
a model-parallel computation,
a tensor-parallel computation,
a pipeline-parallel computation,
a data-parallel computation, or
a hybrid-parallel computation.

15. A method, comprising:
establishing, by a processing unit device, a direct connection to a shared memory region of a compute express link (CXL) compliant memory system,
wherein the CXL compliant memory system is configured to enable zero-copy access to the shared memory region by multiple processing unit devices;
mapping, by the processing unit device, the shared memory region into a virtual memory space of the processing unit device, resulting in a mapped region; and
pinning, by the processing unit device, the mapped region, resulting in a pinned region, to enable direct memory access operations between the processing unit device and the pinned region.

16. The method of claim 15, wherein pinning the mapped region includes pinning the mapped region using a host register function associated with the processing unit device.

17. The method of claim 15, further comprising accessing data stored at the shared memory region by interpreting, by the processing unit device, the mapped region as a tensor without copying the data into memory associated with the processing unit device.

18. The method of claim 15, further comprising performing, by the processing unit device, collective operations with the multiple processing unit devices using the shared memory region as a medium for communication.

19. The method of claim 15, wherein the CXL compliant memory system is configured as a direct access device visible to the multiple processing unit devices.

20. The method of claim 15, further comprising executing, by the processing unit device, a data processing operation using the shared memory region to communicate computation results to one or more processing unit devices, of the multiple processing unit devices.

21. A system, comprising:
a compute express link (CXL) compliant memory system; and
multiple processing units connected to the CXL compliant memory system via a CXL fabric,
wherein one or more components of each processing unit, of the multiple processing units, are configured to:
establish a direct connection to a shared memory region of the CXL compliant memory system,
wherein the CXL compliant memory system is configured to enable zero-copy access to the shared memory region by the multiple processing units;
map the shared memory region into a virtual memory space of the processing unit, resulting in a mapped region; and
pin the mapped region, resulting in a pinned region, to enable direct memory access operations between the processing unit and the pinned region.

22. The system of claim 21, wherein the one or more components of each processing unit, to pin the mapped region, are configured to pin the mapped region using a host register function associated with the processing unit.

23. The system of claim 21, wherein the one or more components of each processing unit are further configured to access data stored at the shared memory region by interpreting the mapped region as a tensor without copying the data into memory associated with the processing unit.

24. The system of claim 21, wherein the one or more components of each processing unit are further configured to perform collective operations with the multiple processing units using the shared memory region as a medium for communication.

25. The system of claim 21, wherein the CXL compliant memory system is configured as a direct access device visible to the multiple processing units.
